(19) United States
(12) Patent Application Publication
(10) Pub. No.: US 2013/0043841 A1
(43) Pub. Date: Feb. 21, 2013

(54) CIRCUIT AND METHOD OF MEASURING VOLTAGE OF THE BATTERY

(71) Applicant: PEI-LUN WEI, Nantou City (TW)

(72) Inventor: PEI-LUN WEI, Nantou City (TW)

(21) Appl. No.: 13/212,155

(22) Filed: Aug. 17, 2011

(51) Int. Cl. H02J 7/04; H02J 7/00

(52) U.S. Cl. 320/118; 320/132; 320/134

(57) ABSTRACT

The present invention provides a circuit and a method of measuring battery voltage. During the charging, the method adopts cycles of charging, stopping charging, discharging, stopping discharging, and measuring voltages. Within each cycle, between the discharging and the measuring voltage, multiple times of pulse discharging are conducted. After each pulse discharging, the battery voltage is immediately measured until the voltage returns to a stable voltage. Then, the next pulse discharging is conducted. By comparing the stable voltages obtained from successive pulse discharging, whether the virtual voltage is removed and whether the real voltage has been obtained is confirmed. Then the real voltage is further used to determine if the battery is fully charged.

### TECHNICAL FIELD OF THE INVENTION

The present invention is generally related to a circuit and method of measuring battery voltage, and more particularly to a circuit and method of measuring the real voltage of a rechargeable battery and using the measurement to determine if the rechargeable battery is fully charged.

### DESCRIPTION OF THE PRIOR ART

In recent days, as technology advances, portable appliances such as mobile phones, notebook computers, tablet computers, PDAs, MP3/MP4 players, etc., have become indispensable in people's daily life.

For these portable appliances to operate smoothly, the rechargeable battery is one of their key components. With longer endurance, the battery has to be recharged less frequently and thereby offers greater convenience. As such, the endurance is often one of the key factors determining a battery product's market share.

For a conventional rechargeable battery, such as a Li or lead-acid battery, the voltage is commonly used as a measurement of its capacity. When the battery is recharged, the voltage measured is also used to judge whether the battery is fully recharged. Therefore, the accuracy of voltage measurement significantly affects the endurance and operation life of a battery.

The input impedance (Ri) is a key parameter to a battery. The input impedance gradually increases as the battery is put to use for a period of time. This is the so-called battery aging. With greater degree of aging, the endurance of the battery after recharge will be worse.

More specifically, let the charging current to be Ic. A voltage drop Vi (Vi=Ic×Ri) is developed across the input impedance. The measured voltage V_{B}=Vi+V_{B}(tr) where Vi could be referred to as virtual voltage, in contrast to the real voltage V_{B}(tr) of the battery

If the measured voltage V_{B} is used to determine if the battery is fully recharged, the battery's real voltage V_{B}(tr)=V_{B}−Vi. In other words, the battery's real voltage is smaller than the desired, fully charged voltage, and the battery is actually not fully recharged, causing its endurance to deteriorate. This is the major reason why battery ages and why its endurance deteriorates. When the input impedance is greater, the battery's endurance would be even worse. Therefore, if the battery's real voltage V_{B}(tr) could be obtained during recharging and used to determine the condition of full recharge, the recharging could be prevented from the impact of the input impedance and a fully recharged battery could be achieved.

Actually, besides Ri, the input impedance also contains a capacitance Ci series- and/or parallel-connected to Ri. Therefore, the virtual voltage Vi would last for a period of time when recharging stops. In addition, the input impedance would also vary depending on the degree of aging and charging parameters. To measure the battery's real voltage, as such, a charging method involving four steps: charging, stopping charge, discharging, and stopping discharge, is developed to deplete the virtual voltage Vi and then to measure the real voltage. However, the virtual voltage Vi and the capacitance Ci are hard to estimate, it would be very difficult to accurately deplete the virtual voltage Vi without wasting the battery's stored electricity and obtain the battery's real voltage.

### SUMMARY OF THE INVENTION

To obviate the foregoing shortcomings, the present invention provides a circuit and method of measuring the real voltage of a battery.

The objective of the present invention is to accurately obtain the real voltage of a battery and use it to determine if the battery is fully charged, so that the endurance of the battery is enhanced and less affected by the battery's aging.

To achieve the objective, the present invention provides a circuit and a method of measuring battery voltage to obtain the real voltage of the battery During the charging, the method adopts cycles of charging, stopping charging, discharging, stopping discharging, and measuring voltages. Within each cycle, between the discharging and the measuring voltage, multiple times of pulse discharging are conducted. After each pulse discharging, the battery voltage is immediately measured until the voltage returns to a stable voltage. Then, the next pulse discharging is conducted. By comparing the stable voltages obtained from successive pulse discharging, whether the virtual voltage is removed and whether the real voltage has been obtained is confirmed. Then the real voltage is further used to determine if the battery is fully charged.

The present invention could be extended to the charging of a battery set consisting of multiple series-connected batteries. By using multiple switches, the real voltage of each battery within the battery set could be obtained to determine if the battery is fully charged.

The circuit and method are capable of greatly enhancing the endurance of batteries, even for those batteries that are already aged. A turbulent effect could be induced in the battery's chemical reaction so that the battery is revitalized for an extended operation life.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a waveform diagram showing the voltage variation over time under a continuous pulse discharging mode of the present invention.

FIG. 2 is a schematic diagram showing a circuit of measuring battery voltage according to an embodiment of the present invention.

FIG. 3 is a schematic diagram showing a circuit of measuring the voltages of multiple series-connected batteries according to an embodiment of the present invention.

FIG. 4 is a schematic diagram showing a circuit of measuring the voltages of multiple series-connected batteries according to another embodiment of the present invention.

FIG. 5 is a schematic diagram showing a circuit of measuring the voltages of multiple battery sets according to an embodiment of the present invention.

FIG. 6 is a schematic diagram showing embodiments of the positive and negative switches capable of bi-directional conduction within the circuit of FIGS. 4 and 5.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

For a conventional rechargeable battery, due to the virtual voltage Vi resulted from the battery's capacitance characteristic, the actual stored electricity is less than the battery's capacity. When the battery is discharged, the electricity causing the virtual voltage is consumed first and, then, the actual stored electricity is consumed. During discharging, due to the output impedance, the voltage will drop and, after the discharging stops, the voltage will rise again until a stable voltage is reached. The rising speed (slop) would vary depending on the various parameters of the battery. The stable voltage reached is the correct voltage after discharging. If a measurement is conducted before the stable voltage is attained, and if the measured voltage is used as a reference for determining the status of full charge in a subsequent charging process, the battery would be over-charged and thereby damaged.

Therefore, after a specific discharging period under a specific discharging current, if the battery's virtual voltage is still not completely removed, the stable voltage reached would be higher than that when the battery's virtual voltage is completely removed. The present invention utilizes this feature to determine if a measured voltage is the real voltage of a battery.

The present invention provides a circuit and a method of measuring battery voltage. For each type of battery, a specific discharging current and a specific discharging period are designed. Then, after a battery is charged for some time, the charging stops and discharging is conducted with a continuous pulse discharging mode.

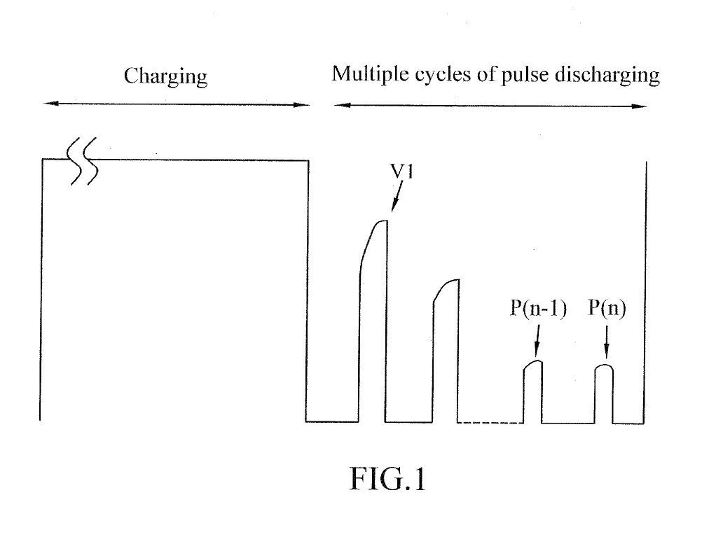

In an embodiment of the present invention, the voltage variation over time under the continuous pulse discharging mode is depicted in FIG. 1. As illustrated, after a specific discharging time, the voltage is measured in real time and compared with the voltage measured last time. When the difference between the voltage V(n) measured in the nth time and the voltage V(n−1) measured in the (n−1)th time is less than a default value, the voltage V(n) is considered a stable voltage under this pulse discharging cycle and is defined as a first stable voltage P(1). Then a next pulse discharging cycle as described above is conducted and a 2^{nd} stable voltage P(2) would be obtained. As such, every cycle has a corresponding stable voltage. If the difference between P(n) and P(n−1) is less than a default value, the virtual voltage is considered to be completely removed and P(n) is considered to be the real voltage of the battery.

For some battery of less capacity, its voltage stabilizes at a faster rate. The measurement of its real voltage could be simplified by only waiting a specific period of time before making the measurement.

If there are too many pulse discharging cycles required to obtain the real voltage of the battery and a lengthened charging time is as such resulted, to improve this problem without consuming too much electricity from the battery, the first pulse of each cycle could be set to a variable interval t1 while the rest of the pulses are of a fixed interval. When the number of pulses of a previous cycle exceeds a default value, t1 is increased with a fixed increment in the next cycle. When t1 is as such increased to an upper limit, t1 remains unchanged. When the number of pulses of a previous cycle is less than a default value, t1 is decreased in the next cycle. When t1 is as such decreased to a lower limit, t1 remains unchanged. In this way, the real voltage of a battery could be more effectively measured.

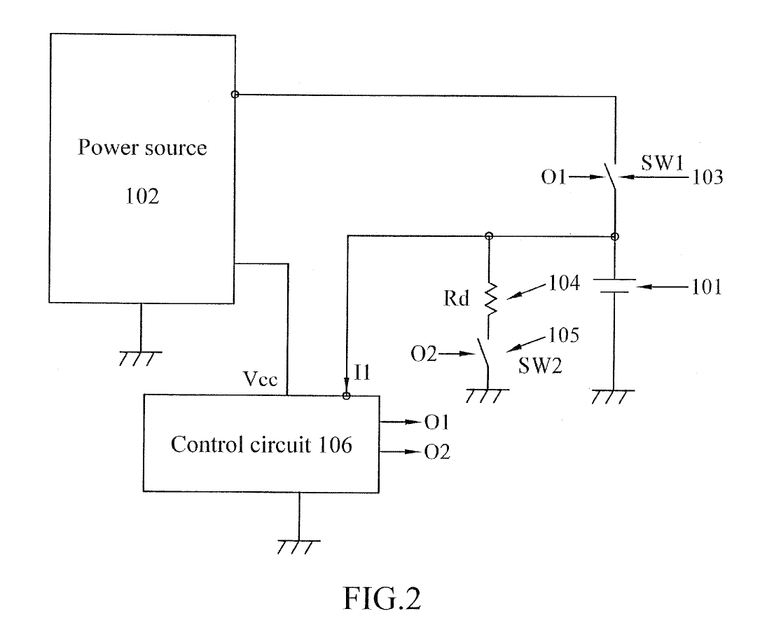

FIG. 2 is a schematic diagram showing a circuit of measuring battery voltage according to an embodiment of the present invention. The circuit contains a battery 101, a power source 102 for charging, a charging switch (SW1) 103, a discharging resistor (Rd) 104, a discharging switch (SW2) 105, and a control circuit 106. The power source 102 could take an alternate-current (AC) or direct-current (DC) input and produces a DC output. The DC output, for both charging the battery 101 and driving the control circuit 106, could be a constant-current output, constant-voltage output, or is power-factor corrected, which are all achieved by the power source 102's internal circuit or by the control circuit 106, or by both. The charging switch 103 is series-connected between the power source 102 and the battery 101 for conducting and disrupting the charging current, and is controlled by the control circuit 106. The discharging resistor 104 is series-connected between the battery 101 and the discharging switch 105 for limiting the discharging current. The discharging switch 105 is series-connected between the discharging resistor 104 and ground for conducting and disrupting the discharging current. The control circuit 106, involving a single-chip control circuit, is for detecting battery voltage, engaging and disengaging the charging switch 103 to control the charging current, and engaging and disengaging the discharging switch 105 to control the discharging current, so as to carry out the charging process. The continuous pulse discharging mode and voltage comparison described above are all built in the control circuit 106.

With the foregoing circuit and method, a battery's real voltage could be effectively measured and used as a reference to decide if the battery is fully charged. As such, not only a battery could be fully charged, but also, for an already aged battery, its endurance could be enhanced. Additionally, the cyclic discharging triggers a turbulent effect in the battery's chemical reaction, preventing crystalline substances from depositing on the electrodes and dissolving the crystalline substances already accumulated on the electrodes. An aged battery is therefore revitalized and its operation life is extended and, as such, a less number of batteries will be consumed which is a significant contribution to environment protection.

In some embodiments where multiple batteries are involved, the same method could be applied with multiple switches to determine the real voltages of these batteries and whether they are fully charged.

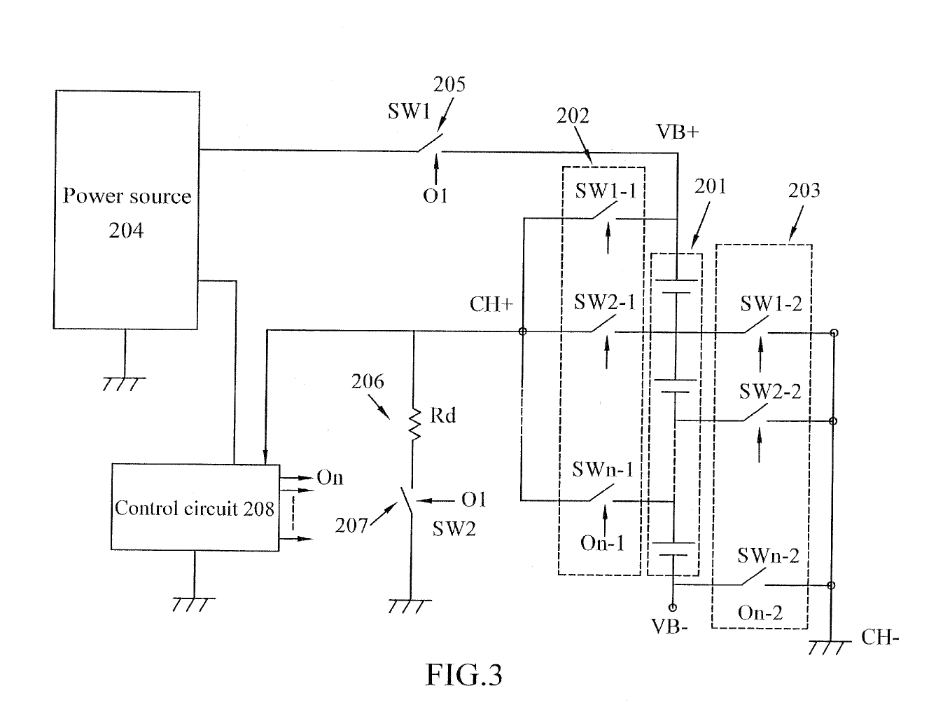

FIG. 3 is a schematic diagram showing a circuit of measuring the voltages of multiple series-connected batteries according to an embodiment of the present invention. The circuit contains a battery set 201 consisting of a number of series-connected batteries, a set of positive switches (SWn−1) 202, a set of negative switches (SWn−2) 203, a power source 204, a charging switch (SW1) 205, a discharging resistor (Rd) 206, a discharging switch (SW2) 207, and a control circuit 208. Within the battery set 201, the positive and negative terminals of each battery are connected to an end of a positive switch (SWn−1) 202 and a negative switch (SWn−2) 203, respectively. The other ends of all positive switches 202 are coupled together at a first terminal CH+. Similarly, the other ends of all negative switches 203 are coupled together at a second terminal CH−. When the corresponding positive and negative switches SWn−1 and SWn−2 of the nth battery of the battery set 201 are engaged while the other positive and negative switches 202 and 203 are disengaged, a path from CH+, through the positive switch SWn−1, the positive terminal of the nth battery, the negative terminal of the nth battery, and the negative switch SWn−2, to CH− is established and only the nth battery is discharged without affecting the other batteries. The power source 204 could take an alternate-current (AC) or direct-current (DC) input and produces a DC output. The DC output, for both charging the battery set 201 and driving the control circuit 208, could be a constant-current output, constant-voltage output, or is power-factor corrected, which are all achieved by the power source 204's internal circuit or by the control circuit 208, or by both. The charging switch 205 is series-connected between the power source 204 and a positive terminal VB+ of the battery set 201 for conducting and disrupting the charging current, and is controlled by the control circuit 208. The discharging resistor 206 is series-connected between CH+ and the discharging switch 207 for limiting the discharging current from CH+. The discharging switch 207 is series-connected between the discharging resistor 206 and ground for conducting and disrupting the discharging current. The control circuit 208 is for detecting battery voltage, engaging and disengaging the various switches so as to carry out the charging process.

In the present embodiment, the control circuit 208, after charging stops, could conduct pulse discharging on each battery, by controlling the positive and negative switches 202 and 203, to measure the real voltage of each battery and to determine whether each battery is fully charged. The control circuit 208 measures the voltage at CH+, and deducts the voltage drops of the positive and negative switches SWn−1 and SWn−2 to obtain the real voltage of the nth battery.

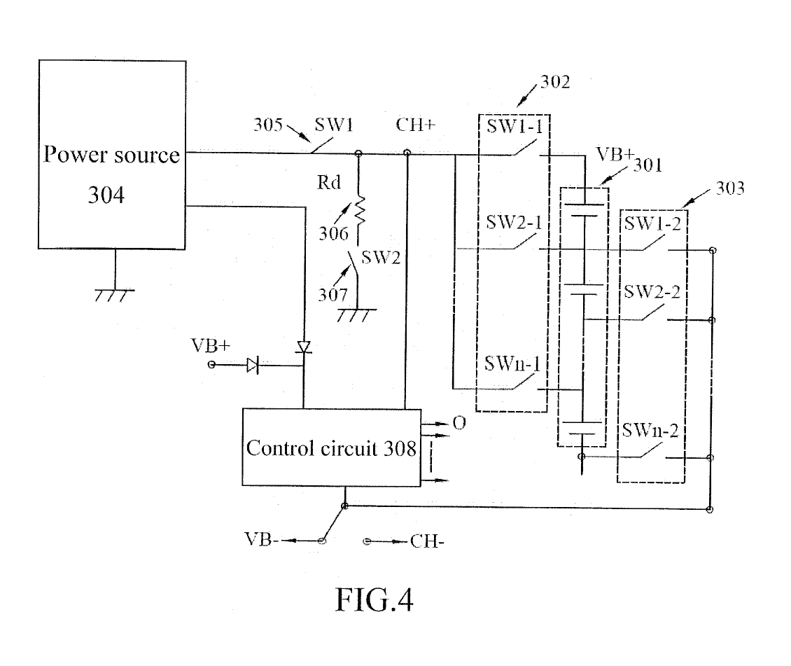

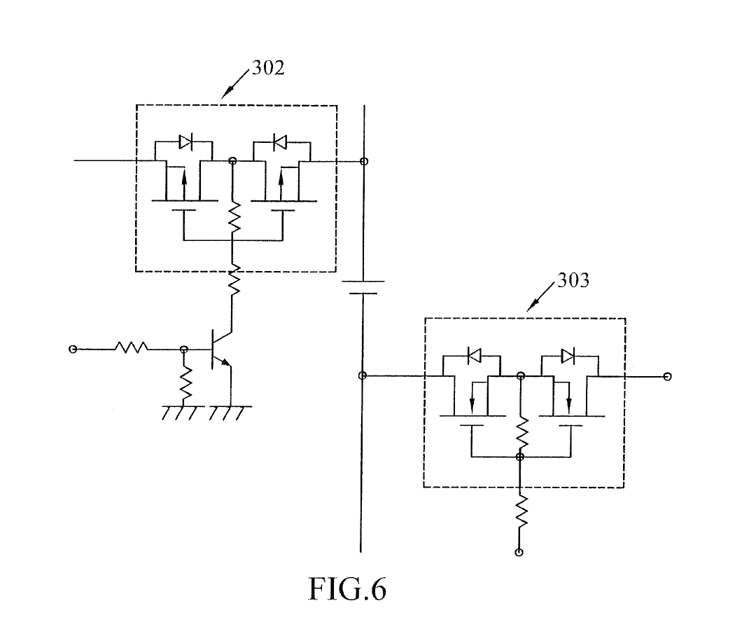

FIG. 4 is a schematic diagram showing a circuit of measuring the voltages of multiple series-connected batteries according to another embodiment of the present invention. The circuit contains a battery set 301 consisting of a number of series-connected batteries, a set of positive switches (SWn−1) 302 capable of bidirectional conduction, a set of negative switches (SWn−2) 303 capable of bidirectional conduction, a power source 304, a charging switch (SW1) 305, a discharging resistor (Rd) 306, a discharging switch (SW2) 307, and a control circuit 308. Each of the positive and negative switches 302 and 303 could be a mechanical relay switch or a semiconductor switch. For example, as shown in FIG. 6, a positive switch 302 contains two series-connected P-type MOSFETs, and a negative switch 303 contains two series-connected N-type MOSFETs. Therefore, under the control of the control circuit 308, each of the positive and negative switches 302 and 303 could be bi-directionally conducting when engaged or bi-directionally shutting down when disengaged. The power source 304 could take an alternate-current (AC) or direct-current (DC) input and produces a DC output. The DC output, for both charging the battery set 301 and driving the control circuit 308, could be a constant-current output, constant-voltage output, or is power-factor corrected, which are all achieved by the power source 304's internal circuit or by the control circuit 308, or by both. The charging switch 305 is series-connected between the power source 304 and a positive terminal VB+ of the battery set 301 for conducting and disrupting the charging current, and is controlled by the control circuit 308. The discharging resistor 306 is series-connected between a first terminal CH+ and the discharging switch 307 for limiting the discharging current from CH+. The discharging switch 307 is series-connected between the discharging resistor 306 and ground for conducting and disrupting the discharging current. The control circuit 308 is jointly powered by the power source 304 (between the first terminal CH+ and a second terminal CH−) and by the battery set 301 (between the positive terminal VB+ and a negative terminal VB−). During charging, the ground of the control circuit 308 is coupled to the second terminal CH− and, while the battery set 301 is providing power, the ground of the control circuit 308 is coupled to the negative terminal VB−. The switch of coupling could be externally controlled, for example, by plugging to an AC power or by turning on a powered appliance. In the present embodiment, SW1=SW1−1=SWn−2=ON and the rest of the switches are OFF during charging so that the entire battery set 301 is charged. After the charging stops, each battery of the battery set 301 is pulse discharged and measured individually by controlling the positive and negative switches 302 and 303 to obtain the real voltage of each battery.

In the present embodiment, a balanced charging operation is conducted when a battery is fully charged. In other words, when a battery is fully charged, those not yet fully charged batteries undergo pulse discharging and then are fully charged individually by controlling the positive and negative switches 302 and 303.

In the present embodiment, when the battery set 301 is providing power, the voltage measurement, low-voltage protection, and calculation of residual volume could be conducted for each battery. By the positive terminal VB+ and first terminal CH+ jointly powering the control circuit 308, the charging circuit and the discharging circuit are integrated.

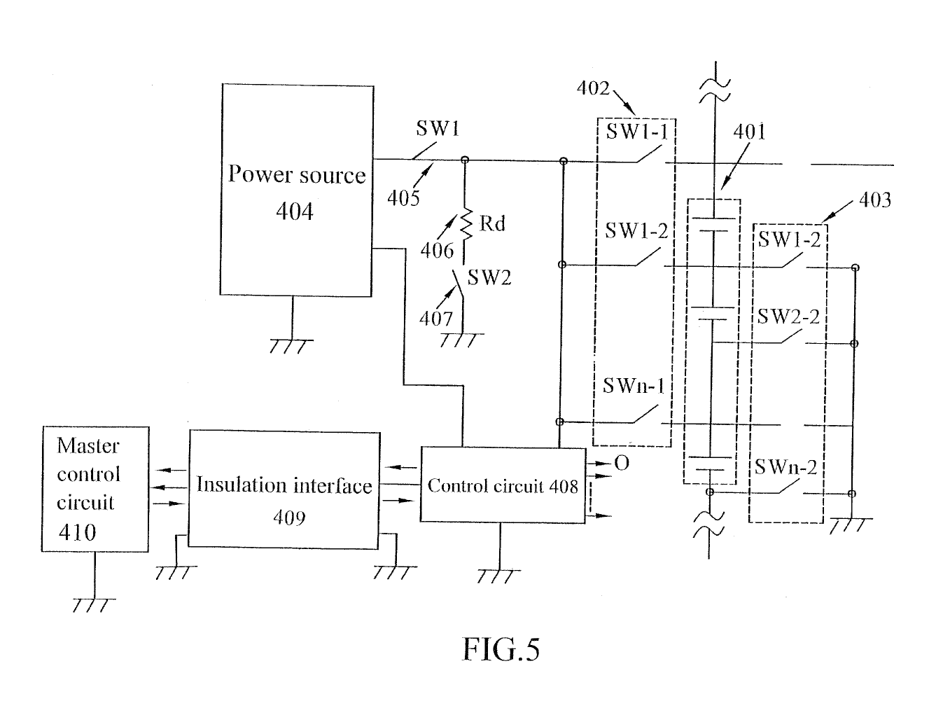

FIG. 5 is a schematic diagram showing a circuit of measuring the voltages of multiple battery sets according to an embodiment of the present invention. The circuit contains a number of series-connected battery sets 401 (only one is depicted in FIG. 5), a set of positive switches (SWn−1) 402 capable of bidirectional conduction, a set of negative switches (SWn−2) 403 capable of bidirectional conduction, a balanced power source 404 insulated from a master power source, a charging switch (SW1) 405, a discharging resistor (Rd) 406, a discharging switch (SW2) 407, and a control circuit 408. Each of the positive and negative switches 402 and 403 could be a mechanical relay switch or a semiconductor switch. For example, a positive switch 402 contains two series-connected P-type MOSFETs, and a negative switch 403 contains two series-connected N-type MOSFETs. Therefore, under the control of the control circuit 408, each of the positive and negative switches 402 and 403 could be bi-directionally conducting when engaged or bi-directionally shutting down when disengaged. The balanced power source 404 insulated from a master power source could take an alternate-current (AC) or direct-current (DC) input and produces a DC output. The DC output, for providing balanced charging current and driving the control circuit 408, could be a constant-current output, constant-voltage output, or is power-factor corrected, which are all achieved by the balanced power source 404's internal circuit or by the control circuit 408, or by both. The charging switch 405 is series-connected between the balanced power source 404 and a first terminal CH+ for conducting and disrupting the balanced charging current, and is controlled by the control circuit 408. The discharging resistor 406 is series-connected in a discharging path for limiting the discharging current. The discharging switch 407 is series-connected between the discharging resistor 406 and ground for conducting and disrupting the discharging current. The control circuit 408 is powered by the balanced power source 404, and communicates with a master control circuit 410 through an insulation interface 409 (such as a photo coupler) by a specific protocol.

With the above design which achieves an independent system, the independent control circuit 408 powered by the independent balanced power source 404 could communicate with the mater control circuit 410 so that, when a mater charging current stops, pulse discharging and voltage measurement could be conducted, and the master control circuit 410 is notified afterwards. As such, while the mater charging current is engaged, individual battery of lower voltage could be synchronously charged, so as to speed up the process of achieving similar voltage from each battery. When discharged, each battery's voltage could be measured as the basis for low-voltage protection and the calculation of residual volume.

For high-voltage battery sets such as those for electrical vehicles, the above circuit could achieve greater endurance and operation life, thereby enhancing their add-on value.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A method of measuring battery voltage, comprising the steps of:
charging a battery from a power source;
stopping charging;
conducting a plurality of cycles of pulse discharging to said battery by a control circuit;
recording a stable voltage P(n) of said battery within each cycle by said control circuit;
comparing said stable voltage P(n) with a previous stable voltage P(n−1) from a previous cycle and determining if the difference is less than a default value; and
if yes, determining if said battery is fully charged by considering a virtual voltage of said battery is removed and defining said stable voltage P(n) as said battery's real voltage.

2. The method of measuring battery voltage according to claim 1, wherein said stable voltage P(n) of each cycle is obtained by the following steps:
conducting a plurality times of discharging within each cycle of pulse discharging and obtaining a measured voltage V(n) after each discharging;
comparing said measured voltage V(n) with a measured voltage V(n−1) from a previous discharging and determining if the difference is less than a second default value; and
if yes, defining said stable voltage P(n) to be said measured voltage V(n).

3. The method of measuring battery voltage according to claim 2, wherein, with each cycle, the period of first discharging is adjusted according to the number of discharging of the previous cycle so as to reduce the charging time and increase performance.

4. The method of measuring battery voltage according to claim 1, wherein the recording said stable voltage P(n) is conducted after a specific period after stopping discharging.

5. A circuit of measuring battery voltage, comprising:
a battery;
a power source coupled to said battery;
a charging switch series-connected between said power source and said battery for conducting or disrupting a charging current;
a discharging resistor coupled to said battery for limiting a discharging current;
a discharging switch series-connected between said discharging resistor and ground for conducting or disrupting said discharging current; and
a control circuit coupled to said power source, said charging switch, said discharging switch for detecting voltage of said battery and engaging/disengaging said charging and discharging switches.

6. The circuit of measuring battery voltage according to claim 5, wherein said power source takes an AC or DC input and produces a DC output.

7. The circuit of measuring battery voltage according to claim 6, wherein said DC output is one of a constant-current output, a constant-voltage output, and a power-factor corrected output achieved by one of an internal circuit of said power source, by said control circuit, and by both for providing a charging current and powering said control circuit.

8. A circuit of measuring battery voltage, comprising:
a battery set consisting of a plurality of batteries;
a plurality of positive switches, each having an end connected a positive terminal of a corresponding battery and the other end connected to a first terminal CH+;
a plurality of negative switches, each having an end connected to a negative terminal of a corresponding battery and the other end connected to a second terminal CH−;
a power source coupled to said battery set;
a charging switch series-connected between said power source and a positive terminal VB+ of said battery set for conducting or disrupting a charging current;
a discharging resistor coupled to said first terminal CH+ for limiting a discharging current;
a discharging switch series-connected between said discharging resistor and ground for conducting or disrupting said discharging current; and
a control circuit coupled to said battery set, said positive and negative switches, said power source, said charging switch, said discharging switch;
wherein said control circuit, by engaging/disengaging said positive and negative switches, capable of conducting a plurality of cycles of pulse discharging to each battery and measuring a real voltage of each battery so as to determine if each battery is fully charged.

9. The circuit of measuring battery voltage according to claim 8, wherein said real voltage of a battery is determined by measuring a voltage at said first terminal CH+ and then deducting voltage drops of said positive and negative switches.

10. The circuit of measuring battery voltage according to claim 8, wherein, when a positive switch and a corresponding switch are engaged, only a battery connected to said positive and negative switches is discharged.

11. A circuit of measuring battery voltage, comprising:
a battery set consisting of a plurality of batteries;
a plurality of positive switches capable of bidirectional conduction, each having an end connected a positive terminal of a corresponding battery and the other end connected to a first terminal CH+;
a plurality of negative switches capable of bidirectional conduction, each having an end connected to a negative terminal of a corresponding battery and the other end connected to a second terminal CH−;
a power source coupled to said battery set;
a charging switch series-connected between said power source and said first terminal CH+ for conducting or disrupting a charging current;
a discharging resistor coupled to said first terminal CH+ for limiting a discharging current;
a discharging switch series-connected between said discharging resistor and ground for conducting or disrupting said discharging current; and
a control circuit coupled to said battery set, said positive and negative switches, said power source, said charging switch, said discharging switch;
wherein, during charging, said control circuit is powered by said power source and, during discharging, said control circuit is powered by said battery set;
said control circuit, by engaging/disengaging said positive and negative switches, is capable of charging said battery set or a battery of said battery set; and
said control circuit conducts a plurality of cycles of pulse discharging to each battery and measures a real voltage of each battery

12. The circuit of measuring battery voltage according to claim 11, wherein each positive switch is one of a mechanical relay switch and a semiconductor switch.

13. The circuit of measuring battery voltage according to claim 11, wherein each negative switch is one of a mechanical relay switch and a semiconductor switch.

14. The circuit of measuring battery voltage according to claim 11, wherein each positive switch comprises two series-connected P-type MOSFETs; and each negative switch comprises two series-connected N-type MOSFETs.

15. A circuit of measuring the voltage of a battery set consisting of a plurality of batteries within a high-voltage battery system, comprising:
a plurality of positive switches capable of bidirectional conduction, each having an end connected a positive terminal of a corresponding battery and the other end connected to a first terminal CH+;
a plurality of negative switches capable of bidirectional conduction, each having an end connected to a negative terminal of a corresponding battery and the other end connected to a second terminal CH−;
a balanced power source coupled to said battery set and isolated from a master power source;
a charging switch series-connected between said balanced power source and said first terminal CH+ for conducting or disrupting a charging current;
a discharging resistor coupled to said first terminal CH+ for limiting a discharging current;
a discharging switch series-connected between said discharging resistor and ground for conducting or disrupting said discharging current; and
a control circuit powered by said balanced power source, said control circuit communicating with a master control circuit through an insulation interface by a specific protocol.

16. The circuit of measuring battery voltage according to claim 15, wherein each positive switch is one of a mechanical relay switch and a semiconductor switch.

17. The circuit of measuring battery voltage according to claim 15, wherein each negative switch is one of a mechanical relay switch and a semiconductor switch.

18. The circuit of measuring battery voltage according to claim 15, wherein each positive switch comprises two series-connected P-type MOSFETs; and each negative switch comprises two series-connected N-type MOSFETs.
